(19) United States
(12) Patent Application Publication
(10) Pub. No.: US 2008/0228473 A1
(43) Pub. Date: Sep. 18, 2008

(54) METHOD AND APPARATUS FOR ADJUSTING HEARING INTELLIGIBILITY IN MOBILE PHONES

(75) Inventor: Sachie Kinoshita, Minato-ku (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ARI ASSOCIATES, INC., Tokyo (JP)

(21) Appl. No.: 11/733,141

(22) Filed: Apr. 9, 2007

(30) Foreign Application Priority Data
Feb. 9, 2007 (JP) 2007-030073

(51) Int. Cl. G10L 21/00

(52) U.S. Cl. 704/225

(57) ABSTRACT

The present invention relates to a method and apparatus for speech intelligibility enhancement. First, the noise estimator determines the amount of ambient noise when the listener is placed in a high ambient noise environment. Second, the perceptual feature associated with speech intelligibility is enhanced with minimal processing artifacts. Third, the listener's volume gain is automatically and adaptively adjusted based on the psycho-acoustic model. The method and apparatus has ample capability to enhance speech intelligibility in any noisy environment conditions, and hence it can be a more desired solution than manual volume adjustment. Thus, the present invention can be implemented in mobile handsets, telephones, public address systems, and the like.

### CROSS-REFERENCE TO RELATED APPLICATION

This application claims the benefit of Japanese Patent Application No. 2007-030073, filed Feb. 9, 2007, priority from the filing date of which is hereby claimed under 35 U.S.C. § 119 and the disclosure of which is hereby expressly incorporated by reference.

### BACKGROUND

Human speech consists of voiced sound and unvoiced sound. In English, the vowels and some of the consonants are classified as voiced sound. The vocal tract modifies this excitation by introducing the acoustic resonance frequencies of the vocal chords. These resonance frequencies are known as formants. On the other hand, most of the consonants (fricatives, plosives, etc.) are assigned to the unvoiced sound category.

Unvoiced sounds are produced when an air-flow is forced through the vocal chord constriction causing audible turbulence. The constriction can occur in several places between the opening of the vocal chords (glottis) and the mouth. The unvoiced sounds are hence characterized by the stricture of the vocal tract. Vocal chord vibration is not involved in producing the unvoiced sounds and there is no fundamental frequency in the excitation signal and no harmonic structure either.

Wireless communication environments are often associated with considerable ambient or background noise which may make it difficult to clearly transmit and receive intelligible speech at an audible level. As a result, the individuals on either end of a phone conversation may often have to repeat themselves, shout, or raise their voices to be heard over the noise, which can compromise the privacy of the conversation. A person in a noisy environment may also increase the volume of the phone in order to better hear the person speaking on the other end. During the call, manually adjusting the volume level in response may carry missing conversation. In addition, manually increased volume in response to background noise must be later manually decreased to avoid acutely loud reception when the background noise dies down.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the present invention, a method and apparatus is provided for increasing the intelligibility of speech/audio reproduction with minimal processing artifacts, which is intended particularly for use in high ambient noise environments, in which computational and storage complexity are substantially less, and which speech enhancement system can be implemented in a mobile platform which does not require expensive instruments for the implementation of speech intelligibility enhancement systems.

In accordance with another aspect of the present invention, a method and apparatus for speech intelligibility enhancement is disclosed. First, the noise estimator determines the amount of noise when the listener is placed in a high ambient noise environment. Second, the perceptual feature associated with speech intelligibility is enhanced with minimal processing artifacts. Third, the listener's volume gain is automatically and adaptively adjusted based on the psycho-acoustic model.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram showing an overall system structure according to an embodiment of the present invention;

FIG. 2 is a block diagram showing an implementation example on a mobile handset; and

FIG. 3 is a detailed diagram of the speech enhancement part according to an embodiment of the present invention.

### DETAILED DESCRIPTION

A preferred embodiment of the present invention will hereinafter be described in greater detail with reference to the accompanying drawings. It should be noted that when elements are designated by reference numerals throughout the drawings, like elements are designated by like reference numerals even though they are shown in different figures of the drawings. Further, if it is determined that specific descriptions of known related functions or components may unnecessarily make the subject matter of the present invention obscure in the description of the present invention, detailed descriptions thereof will be omitted herein. In addition, the terms used hereinafter are terms defined in consideration of their functions in the present invention and may be changed according to general practices of those skilled in the art. The definitions should be interpreted based on the overall disclosure herein.

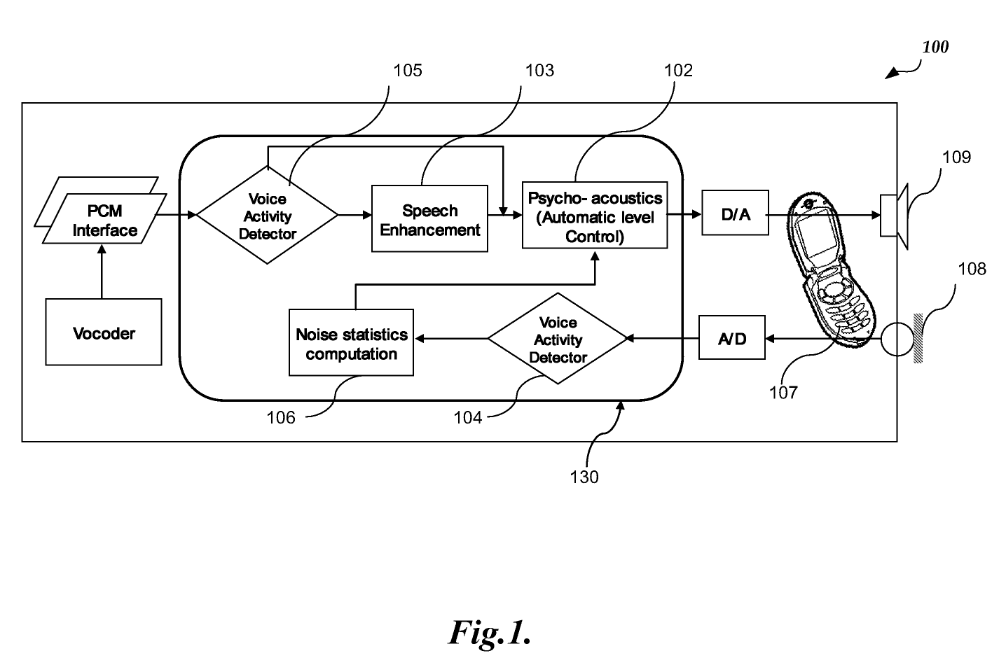

FIG. 1 shows a block diagram 100 depicting an overall structure in accordance with an embodiment of the present invention. The perceptual feature enhancement part 130 comprises an automatic level control part 102, a speech enhancement part 103, a noise statistics computation part 6, and two voice activity detectors (VAD) 104, 105. One VAD 104 is used for the transmitter (Tx) and the other VAD 105 is used for the receiver (Rx). An automatic level control part 102 may be a prior art disclosed in U.S. Pat. No. 6,298,247. In one embodiment, an automatic level control part 102 may be a volume control part which is suitable for filtering audio signals. The automatic level control part 102 can be any device for adaptive volume control, operating within, and utilizing the existing infrastructure of, a wired or a wireless telecommunications network.

During the call, when the Rx VAD 105 determines voice activity, the speech enhancement part 103 along with the automatic level control part 102 is operated based on estimated noise level, calculated by the noise statistics computation part 106, from the microphone 108. The psycho-acoustic model is used to determine when and how much gain should be increased. This operation criterion is based on the amount of difference between the Rx energy level and Tx noise energy.

The speech enhancement part 103 is operated along with the automatic level control part 102. However, when the environmental noise is not enough to activate the automatic level control part 102, the speech enhancement part 103 is activated independently. This implies that the Rx speech signal gets some enhancement without any gain adjustment. This is one of the unique aspects of the present invention and further discussion is included in the following section.

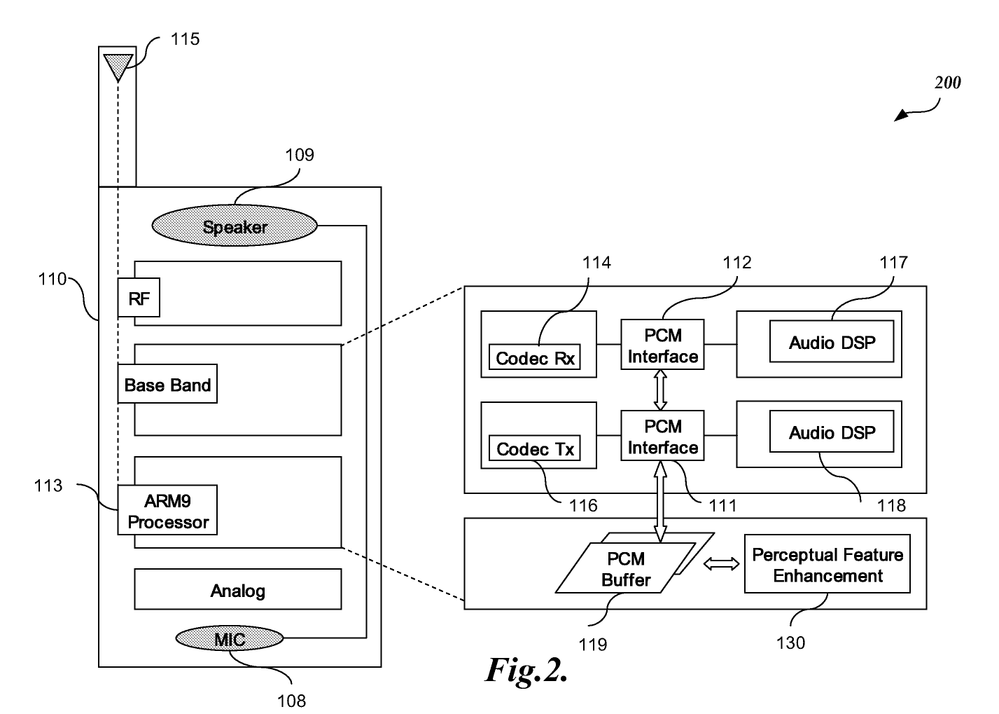

With reference to FIG. 2, a block diagram 200 depicting an implementation example on a mobile handset is illustrated in accordance with an embodiment of the present invention. The described structure utilizes built-in hardware components, i.e., microphone 108 and speaker 109. So, no additional hardware components are required for the implementation.

The perceptual feature enhancement part 130 and the base station communicate with each other using the Tx/Rx PCM interface 111, 112. Processes described below may be implemented on a micro-processor 113, e.g., ARM9-EJS. However, such microprocessor is only used herein as an example, and is not intended to be limiting.

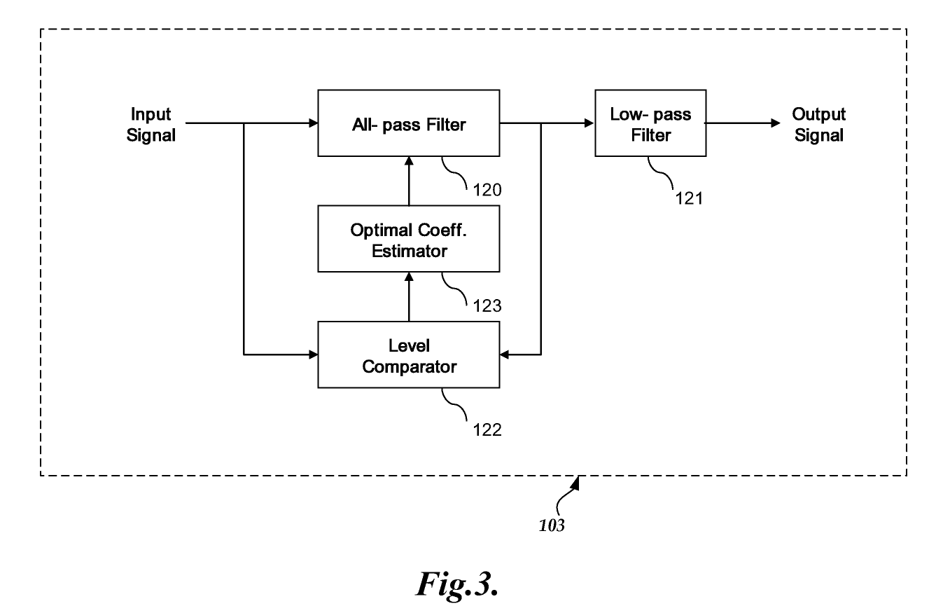

With reference to FIG. 3, the speech enhancement part 103 of FIG. 1 is depicted in detail in accordance with an embodiment of the present invention.

In one embodiment, the speech enhancement part 103 is operated as a shelving filter. The input speech signal is processed by a digital high pass shelving filter whose cut-off frequency is adjusted such that the amplitude level of the output speech envelope is approximately equal to the amplitude level of input speech envelope. When the amplitude level of the input speech envelope is greater than the amplitude level of the output speech signal envelope, the cut-off frequency of the shelving filter is moved towards a lower value to maintain the equality. When the amplitude level of the input speech envelope is lesser than the amplitude level of the output speech envelope, the cut-off frequency of the shelving filter is moved towards a higher value.

The speech enhancement part 103 designed as a shelving filter has been implemented in discrete-time domain using all-pass filter 120 as follows:

H(z)=L_{π}(1+A(z))/2+L₀(1−A(z))/2 (1)

where L₀ is a gain at zero frequency, L_{π} is a gain at high frequency, and all-pass filter A(z) is

A(z)=−(a+z⁻¹)/(1+az⁻¹) (2)

The shelving filter is tuned by changing the parameter ‘a’ of the all-pass filter 120. For different values of cut-off frequency of the shelving filter, the values of ‘a’ can be computed in advance. These values are preferably stored in a lookup table.

A level detector is used to estimate the amplitude level of the input speech envelope using level comparator 122, and an optimal coefficient estimator 123 calculates the coefficient of the all-pass filter 120 as shown in FIG. 3.

To estimate the amplitude level of the input speech envelope, other estimation algorithms such as root mean square level estimate, envelope detection, rectifier followed by low-pass filter 121, and the like, may also be used.

Accordingly, the input speech is filtered using the tunable high pass shelving filter to yield output enhanced speech.

As shown in FIGS. 1, 2, and 3, a perceptual feature enhancement part 130 may be incorporated in a two way communication system such as a mobile handset 107 or other suitable device. The received speech signal is enhanced using the method and apparatus proposed in this disclosure. And the enhanced speech/audio signals are reproduced using one or more speakers 109. In the transmit direction, the proposed method and apparatus can also be used to increase the intelligibility of the transmitted speech/audio signal.

In an illustrative embodiment, the acoustic speech signal is converted to an electrical signal by a microphone 108. The speech signal, in analog or digital format, is processed using the proposed method and apparatus to emphasize the speech intelligibility cues before transmission.

A set of operation steps for automatically adjusting hearing intelligibility is as follows:

First, the amplitude level of input speech is detected by an Rx VAD and the envelope is estimated using a level detector.

Second, the amplitude level of noise signal in Tx is calculated.

In the third step, the system estimates the amount of noise and compares this with a psycho-acoustic model to determine a required gain for automatic hearing level adjustment.

Finally, the system applies the speech enhancement process with or without automatic level adjustment. The speech enhancement process comprises the step of adjusting the cut-off frequency such that the amplitude level of the output speech envelope is approximately equal to the amplitude level of input speech envelope.

If the speech enhancement process is applied without level adjustment, listeners will receive improved word intelligibility without any energy level changes. For heavier noise environments, listeners will receive improved intelligibility with a proper gain adjustment.

It is to be noted that the aforementioned embodiments and examples are described for exemplary purposes. It is contemplated that the above mentioned method and apparatus may be implemented in mobile handsets, telephones, public address systems, and the like

While illustrative embodiments have been illustrated and described, it will be appreciated that various changes can be made therein without departing from the spirit and scope of the invention.

The embodiments of the invention in which an exclusive property or privilege is claimed are defined as follows:

1. An apparatus for automatically adjusting hearing intelligibility, the apparatus comprising:
a Rx voice activity detecting means for detecting an amplitude level of input speech;
a Tx voice activity detecting means for calculating an amplitude level of noise signal; and
a speech enhancement means for adjusting a gain based on the amplitude level of input speech detected by said Rx voice activity detecting means and the amplitude level of noise signal calculated by said Tx voice activity detecting means.

2. The apparatus as claimed in claim 1, wherein said speech enhancement means comprises a filter whose cut-off frequency is adjusted such that the amplitude level of the output speech envelope is approximately equal to the amplitude level of input speech envelope.

3. A method for automatically adjusting hearing intelligibility, comprising the steps of:
detecting an amplitude level of input speech;
calculating an amplitude level of noise signal; and
adjusting a gain based on the amplitude level of input speech detected and the amplitude level of noise signal calculated.

4. The method as claimed in claim 3, further comprising the step of adjusting the cut-off frequency such that the amplitude level of the output speech envelope is approximately equal to the amplitude level of input speech envelope.
